(19) United States
(12) Patent Application Publication
(10) Pub. No.: US 2009/0047893 A1
(43) Pub. Date: Feb. 19, 2009

(54) Building Plenum

(76) Inventor: Larry Zimmerman, Stow, MA (US)

Correspondence Address: Gerald M. Bluhm;Tyco Safety Products, 50 Technology Drive, Westminster, MA, 01441-0001, US

(21) Appl. No.: 11/839,331

(22) Filed: Aug. 15, 2007

(51) Int. Cl. F24F 7/00; G08B 23/00; A62C 35/00

(52) U.S. Cl. 454/237; 340/501; 169/16

(57) ABSTRACT

A building plenum is provided. The building plenum may include an assembly or housing and multiple building utility and safety infrastructures (such as fire, lighting, ventilation, and other building infrastructure). The building plenum may be constructed at a manufacturing facility for subsequent installation in a building. In this way, the building infrastructure may be quickly and efficiently installed in the building, such as by mounting the building plenum on a ceiling as part of a ceiling cover, ceiling tile, or the like. The building plenum may have different configurations (including different building utility and safety infrastructures), different lengths and widths, and different cover appearances (or other ornamentation).

### BACKGROUND OF THE INVENTION

Buildings typically include one or more safety devices, such as fire detectors, sprinkler systems, speakers, emergency lighting, notification strobe lights, horns and speakers, video monitoring cameras, etc. These devices are normally mounted in the ceiling. For example, the fire detectors for the fire alarm system and discharge heads for the sprinkler system may be mounted at predetermined distances from one another. The installation of the fire detectors, discharge heads and the other safety devices in a building may be labor intensive and requires multiple ceiling penetrations for mounting. Specifically, it may require significant time (and associated cost) for a skilled laborer to install the fire detectors (and attendant circuitry) and the sprinkler heads (and attendant piping). Further, the holes and ceiling penetrations in installing the fire detectors, sprinkler heads, and other safety devices may be unsightly. The ceiling may contain multiple dissimilar devices such as building utility devices such as lighting, vents, wireless network hubs, routers, and safety devices such as smoke detectors, sprinklers, etc. that to many are architecturally unpleasing. Therefore, a need exists to install the safety devices in a more cost efficient manner and a manner that in many situations is deemed more architecturally pleasing.

### SUMMARY OF THE INVENTION

A building plenum is provided. The building plenum may include an assembly or housing and multiple building utility and safety infrastructures (such as fire, safety, networking, lighting, ventilation, and other building infrastructure). The building plenum may be constructed at a manufacturing facility for subsequent installation in a building. In this way, the building infrastructure may be quickly and efficiently installed in the building, such as by mounting the building plenum on a ceiling as part of a ceiling cover, ceiling tile, or the like. For example, the on-site installation in the building may be simplified to one set of connections per building plenum, rather than requiring connections to each individual device. The building plenum may have different configurations (including different building utility and safety infrastructures), different lengths and widths, and different cover appearances (or other ornamentation).

The building plenum may include a housing, one or more devices, a power input for providing power to the building plenum, a communication port, building utility connections and a means to fasten the plenum to the ceiling or overhead building structure using apparatus such as screws, bolts or snap fasteners. The one or more devices may include devices for the building infrastructures. For example, the one or more devices may include one or more fire alarm devices, such as a smoke detector, sprinkler piping and discharge head(s), notification appliances, etc. Also, the one or more devices may include heating and ventilation device(s) and lighting device(s). In particular, the heating and ventilation device(s) may include an inlet vent on an exterior of the housing, an outlet vent on the exterior of the housing, and ducts connecting the inlet vent with the outlet vent. The lighting device may include a light on an exterior of the housing or internally to the housing where light is transmitted through translucent or transparent parts of the housing or indirectly reflected via the ceiling. The light may be electrically connected to the power input and controllable via a switch external to the building plenum, the switch may be located in the same room in the building as the building plenum or some other location as determined by the installer or may be controlled via building automation systems.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is perspective view of one example of the building plenum.

FIG. 2 is a side view of the building plenum depicted in FIG. 1.

FIG. 3 is a perspective view of sprinkler and various devices within the building plenum depicted in FIG. 1.

FIG. 4 is a perspective view of ventilation and lighting within the building plenum depicted in FIG. 1.

FIG. 5 is a block diagram of the controller for the building plenum.

### DETAILED DESCRIPTION OF THE INVENTION

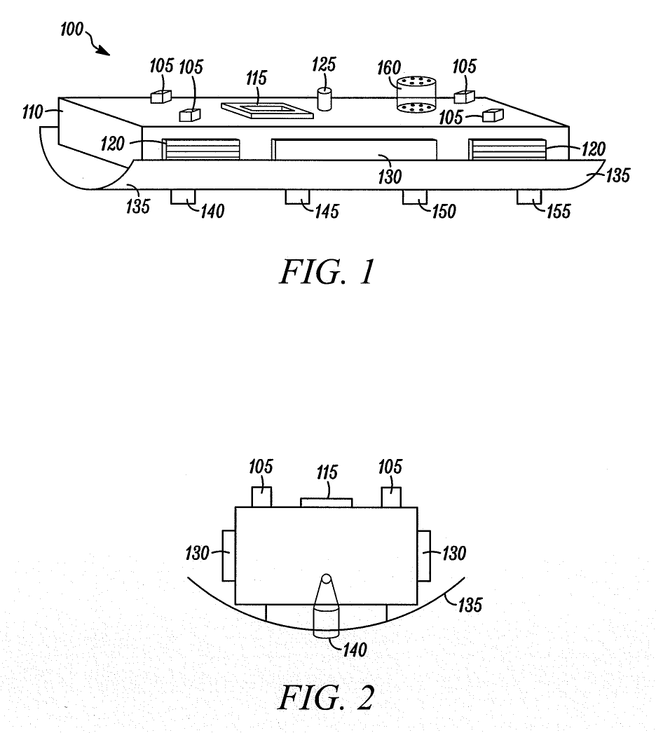

FIG. 1 is perspective view of one example of the building plenum 100. FIG. 2 is a side view of the building plenum depicted in FIG. 1. The building plenum 100 may include one or more fasteners 105 on one or more sides of the housing 110. The fasteners 105 may comprise ceiling mounts, such as snap fittings, screws or other attachment fittings, that connect with the ceiling, ceiling infrastructure, other surface of a room in the building, or other building structure. Further, as shown in FIG. 1, the housing 110 may comprise a rectangular shape and may include one or more devices, as discussed in more detail below. The rectangular shape is merely for illustrative purposes. The housing 110 may comprise various shapes to accommodate various size rooms (including various sized ceilings) and to accommodate different devices housed within housing 110.

The building plenum 100 may further include devices for various building infrastructure, such as HVAC (heating, ventilation, and air conditioning), fire, lighting, security, video cameras, wireless network hubs or routers, etc. For example, the building plenum 100 may include one or more ventilation inlets (one ventilation inlet 115 is depicted in FIG. 1), one or more ventilation outlets (two ventilation outlets 120 are depicted in FIG. 1), and ducts (shown in FIG. 4). The HVAC for the building plenum 100 may thus be manufactured off-site for subsequent installation in the building. The installation may comprise connecting the ventilation inlet 115 to ductwork in the building. In this way, the installation on-site may be standardized, and thereby accelerated, reducing the costs associated with installation.

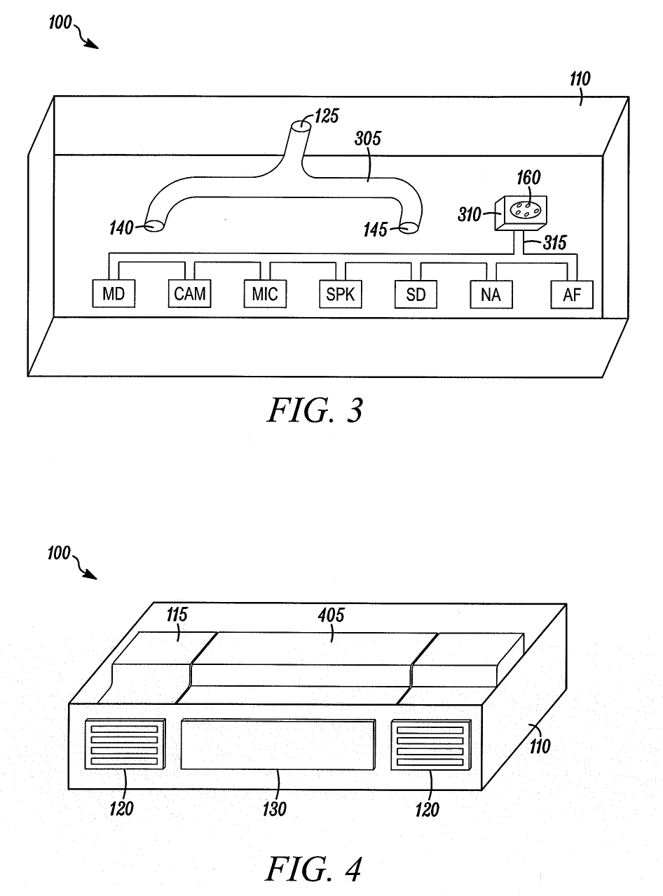

As another example, the building plenum 100 may include one or more devices associated with a fire alarm system (such as sprinkler piping and discharge head(s), smoke detector(s), speaker(s), notification appliance(s), etc.). As shown in FIG. 1, the building plenum 100 may include a water inlet 125 for connecting with a water line exterior to the housing 110 of the building plenum. Discussed in more detail with respect to FIG. 3, the water inlet 125 may be connected with piping and one or more discharge heads 140. Again, the installation of the sprinkler piping and discharge heads in a room in the building may be hastened by manufacturing the building plenum with the sprinkler piping/discharge head(s) off-site and connecting the water inlet 125 to piping in the building. The building plenum 100 may also include one or more smoke detectors 145, one or more speakers 150, and one or more notification appliances 155 (such as a strobe).

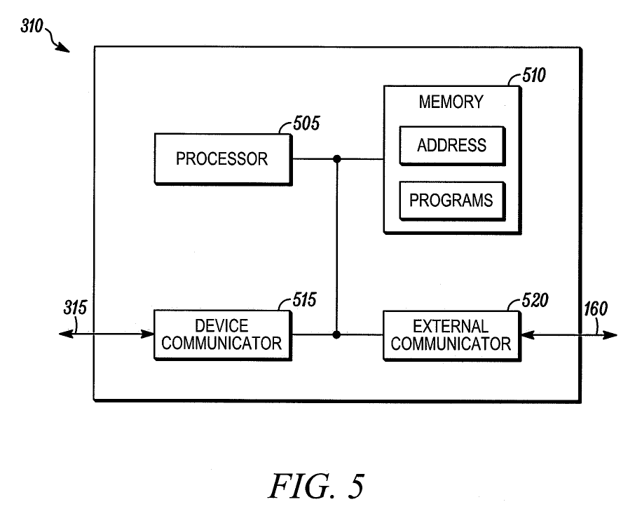

As discussed in more detail in FIGS. 3 and 5, the smoke detector 145, speaker 150, notification appliance 155, and other devices may communicate with a building plenum controller 310, which in turn may communicate (wired or wirelessly) with a control panel (not shown) external to the building plenum 100. For example, in a wired communication with a control panel, the building plenum 100 may include a network connector 160 that enables a wired connection. The network connector 160 enables the receipt of a message or command from the control panel. For example, the control panel may send a command to the building plenum 100 to control one or more devices within the building plenum 100 (such as activating a notification device, such as a siren or horn). As another example, the control panel may send a message to the building plenum 100 to output a specific message using one or more devices within the building plenum 100 (such as outputting a message via a speaker or other notification device to exit the building). The controller 310 (discussed below) may control the interpretation of the commands or messages received.

The network connector 160 may include one or more pins for connection with another connector external to the housing 110 of the building plenum 100. One of the pins the network connector 160 may be designated as a power input to the building plenum 100. The power input may be used to power one, some, or all of the devices housed in the building plenum 100. Alternatively, a power line input, separate from the network connector 160, may be input to the building plenum 100. As shown in FIG. 1, the network connector 160 may be positioned on the housing 110 of the building plenum 100.

The building plenum 100 may include one or more devices associated with a lighting system. For example, the building plenum 100 may comprise one or more lights 130. The light 130 may be positioned on the housing 110, such as a side of the housing 110 of the building plenum 100 to generate indirect lighting. The light 130 may also be positioned so that it is at least partly in the housing 110 (such as entirely in the housing 110). The light generated by light 130 may exit the interior of the housing 110 via a hole in the housing 110. For example, the housing 110 may include a hole or opening in the housing's upper portion (so that when the building plenum 100 is installed, the hole faces the ceiling). Light may exit the light 130, be transmitted through the hole of the housing 110, and be reflected off of the ceiling. It this way, the light may illuminate the room indirectly. The light generated by light 130 may exit the interior of the housing 110 via a translucent portion (or a transparent portion) of the housing 110. For example, one or more side, top, or bottom sections of the housing 110 may be partly or fully composed of a translucent material. In this way, light generated by light 130 may exit the housing through the translucent material.

The light 130 may be controllable from a switch (not shown) which is external to the building plenum 100. The switch may be electrically connected to the light 130 via the network connector 160 or via a separate line input to the building plenum 100. The switch may be positioned in the room in which the building plenum 100 is mounted. In this way, the light 130 of the building plenum 100 may be controlled by an occupant of the room. The switch may also be located in another part of the building or be mobile and communicate with the plenum controller to control the lighting or other devices such as video cameras in the plenum. Further, a cover 135 may be used in order to conceal part of the housing 130, as shown in FIG. 1. The cover 135 may be of differing shapes. The cover for the bottom of the plenum, such as the lower side of the plenum when it is mounted on the ceiling, may be of various shapes, sizes and color. FIG. 1 shows a curved cross section of the cover 135. The cover may also be flat or extend past the plenum on the sides and then have wings that angle up, at optional angles, towards the ceiling. This is done in such a manner that the curved extension or the wings or similar mechanical design visibly hides the plenum when viewed by building occupants. They may also be translucent to allow transmission of light or be coated on the top side to reflect light towards the ceiling when indirect lighting is desired.

FIG. 3 is a perspective view of sprinkler piping/discharge heads and various devices within the building plenum 100 depicted in FIG. 1. The water inlet 125 may be connected with piping 305 and one or more discharge heads 140. The means of connection is using industry available piping connections. Further, multiple devices are depicted within the building plenum 100. The multiple devices include a motion detector MD, a camera CAM, a microphone MIC, a speaker SPK, a smoke detector SD, a network appliance NA, and an air filter AF. One, some, or all of the devices may communicate with a building plenum controller 310 via a bus 315. The building plenum controller 310 may be connected to the network connector 160 for communication with the control panel. The connector may be a commercially available connector or industry standard direct wiring means that complies with local building codes. FIG. 4 is a perspective view of ventilation and lighting within the building plenum depicted in FIG. 1. The ventilation inlet 115 may connect to ducts 405, with the ducts 405 connecting to one or more ventilation outlets 120.

FIG. 5 is a block diagram of the optional building plenum controller 310 for the building plenum. The building plenum controller 310 may include a processor 505, a memory device 510 (which may include volatile and non-volatile memory), a device communicator 515 (which may communicate with the one or more devices, such as a motion detector MD, a camera CAM, a microphone MIC, a speaker SPK, a smoke detector SD, a network appliance NA, and an air filter AF, housed in the building plenum 100), and an external communicator 520 (which may connect with the network connector 160 for communication with an external control panel). The memory 510 may include an address that uniquely identifies the building plenum 100. In this way, the processor 505 may access the address in the memory 510, and include the address in communications sent to the control panel (such as including the address in a header of a transmission sent to the control panel). In some installations the controller 310 might not be used as the communications of the motion detector MD, a camera CAM, a microphone MIC, a speaker SPK, a smoke detector SD, a network appliance, etc. are wired directly to one or more data or controller networks or other building utility infrastructure. Further, the controller 310 may automatically communicate with the control panel when one or more of the devices within the building plenum 100 is activated. For example, if one or more of the fire alarm devices is activated (such as a smoke detector being activated), the controller 310 of the building plenum 100 may send a message to the control panel.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A building plenum comprising:
a housing;
at least one fire system device at least partially housed within the housing;
at least one power input for providing power to the building plenum;
at least one communication port in communication with at least one of the fire system device, the communication port for network communication with a control panel external to the building plenum; and
at least one fastener on the housing for affixing the building plenum to a building structure.

2. The building plenum of claim 1, wherein one of the fire system devices comprises a smoke detector.

3. The building plenum of claim 1, wherein one of the fire system devices comprises sprinkler piping and at least one discharge head; and
further comprising at least one hole in the housing, the hole connected to the sprinkler piping, the hole for connecting to water piping external to the housing.

4. The building plenum of claim 1, wherein one of the fire system devices comprises a notification device; and
wherein the control panel communicates a message via the communication port for output on the notification appliance.

5. The building plenum of claim 1, wherein one of the fire system devices comprises a notification device; and
wherein the control panel communicates a message via the communication port for control of the notification appliance.

6. The building plenum of claim 1, wherein the communication port comprises a wired communication device including a network connector, the network connector include at least one pin for power input
wherein the power input is electrically connected to the at least one pin.

7. The building plenum of claim 1, wherein the communication port comprises a wireless communication device; and
wherein the building plenum communicates wirelessly with the control panel via the communication port.

8. The building plenum of claim 1, further comprising:
a ventilation inlet on an exterior of the housing;
a ventilation outlet on the exterior of the housing; and
at least one duct connecting the ventilation inlet to the ventilation outlet.

9. The building plenum of claim 1, further comprising lighting at least partly on an exterior of the housing, the lighting electrically connected to the power input and controllable via a controller external to the building plenum.

10. The building plenum of claim 9, wherein the controller is a switch.

11. The building plenum of claim 9, wherein the controller sends a control message.

12. The building plenum of claim 1, wherein the housing comprises a translucent portion; and
further comprising lighting at least partly on an interior of the housing with light from the lighting transmitted through the translucent portion, the lighting electrically connected to the power input and controllable via a controller external to the building plenum.

13. The building plenum of claim 1, wherein the building plenum is installed in a room with a ceiling in the building;
wherein the housing comprises a hole in a top portion of the housing, with the hole facing the ceiling when the building plenum is installed in the room; and
further comprising lighting at least partly on an interior of the housing with light from the lighting transmitted through the hole in the top portion of the housing so that the light transmitted through the hole is reflected off of the ceiling and illuminates the room indirectly, the lighting electrically connected to the power input and controllable via a controller external to the building plenum.

14. The building plenum of claim 1, wherein the at least one fastener on the housing is adapted to be affixed to a ceiling of the building.

15. A building plenum comprising:
a housing;
at least one fire system device at least partially housed within the housing;
at least one of a lighting or ventilation device at least partly within the housing and controllable from external to the building plenum;
at least one power input for providing power to the building plenum;
at least one communication port in communication with the fire system device, the communication port for network communication with a control panel external to the building plenum; and
at least one fastener on the housing for affixing the building plenum to a building structure.

16. The building plenum of claim 15, wherein the ventilation device comprises:
a ventilation inlet on an exterior of the housing;
a ventilation outlet on the exterior of the housing; and
at least one duct connecting the ventilation inlet to the ventilation outlet

17. The building plenum of claim 15, wherein the lighting is electrically connected to the power input and controllable via a controller external to the building plenum.

18. The building plenum of claim 15, wherein the fire system device comprises a smoke detector.

19. The building plenum of claim 15, wherein the fire system device comprises sprinkler piping and at least one discharge head; and
further comprising at least one hole in the housing, the hole connected to the sprinkler piping, the hole for connecting to water piping external to the housing.

20. The building plenum of claim 15, wherein the control panel comprises a fire alarm control panel; and
wherein the fire system device comprises a notification appliance; and
wherein the fire alarm control panel communicates a message via the communication port for output on the notification appliance.

21. The building plenum of claim 15, wherein the control panel comprises a fire alarm control panel; and
wherein the fire system device comprises a notification appliance; and
wherein the fire alarm control panel communicates a command via the communication port for control of the notification appliance.
